(19) United States
(12) Patent Application Publication
(10) Pub. No.: US 2005/0016824 A1
(43) Pub. Date: Jan. 27, 2005

(54) System and method for accepting a user control input

(76) Inventors: Andrew Olcott, Brighton, MA (US); Damian Howard, South Boston, MA (US); Lee Zamir, Cambridge, MA (US)

Correspondence Address: FISH & RICHARDSON PC, 225 FRANKLIN ST, BOSTON, MA, 02110, US

(21) Appl. No.: 10/626,349

(22) Filed: Jul. 23, 2003

(51) Int. Cl. H01H 3/00

(52) U.S. Cl. 200/329

(57) ABSTRACT

A system for accepting user input including a switch arranged in an array of switches. Each switch in the array of switches is located at the edge of a pressure member. The system includes a display that displays at least one option and includes a pressure member. The pressure member has multiple sections and is positioned in relation to the array of switches such that when a force is applied, by a user, to one of the multiple sections corresponding to the switch, the pressure member transmits a resulting force to the switch causing a switch actuation. One of the multiple sections of the pressure member is spatially associated with a desired option of the at least one option. The system also includes a control circuit, wherein the control circuit is configured to translate the switch actuation into a system state.

### BACKGROUND OF THE INVENTION

The invention relates to systems and methods for accepting user input for activation of one or more switches.

### SUMMARY OF THE INVENTION

Embodiments of the invention are directed to a system and method for accepting user input provided as a force exerted on a selected segment of a pressure member (e.g., a surface area of plastic, metal, glass or other material to which the user can apply a force) and/or provided by the operation of two controls (e.g., knobs, buttons, shafts, etc.). In particular, in one embodiment, the pressure member is a sheet of plastic that is coupled and/or mounted on four switches (e.g., a device capable of detecting a user input such as a force or “push”; other switches include capacitive, resistive, piezoelectric, mechanical, etc.) located around the periphery (e.g., at the corners of a rectangular shaped pressure member). In one embodiment, the pressure member is an optically transparent sheet of material (e.g., plastic, glass, etc) disposed in front of a display such that the display is visible through the pressure member(the display will be described in more detail later). The display shows options (e.g., input options, menu options) that are spatially associated with sections of the pressure member. When the user exerts a force within a selected section of the pressure member that is close to where the pressure member is mounted and/or coupled to one of the switches, the pressure member transmits a resulting force on the nearby switch, thus actuating the switch.

A section of the pressure member is defined here as an area of the pressure member associated with a switch, such that a force applied by a user within the area of the section is capable of actuating the associated switch. By selecting an appropriate section (e.g., the closest of multiple locations or portions of the pressure member to a particular switch) of the pressure member to apply the force to, the user effectively chooses which switch to activate. The switch actuation in turn changes the system state (e.g., parameters, settings, operations performed, functions, data stored in memory locations, etc.), either directly or through the action of a control circuit coupled to the various switches. In one embodiment, the system is a media player, and in particular is a media player designed for use within a vehicle. Media players may alternatively be media control units, receivers, radios, CD players, video players or other DVD players, or other media devices. Accordingly, the system and method provides a way to accept user input with a less costly alternative than the use of touch screens but offering more flexibility than is provided by fixed controls such as buttons, switches, etc. Embodiments of the invention provide a large surface for users to locate by “tactile feedback” thereby increasing the likelihood of the user being able to initiate input without looking at the input device as contrasted with dedicated push-buttons, knobs and other similar controls. The pressure member is equipped with raised touch areas that allow the user to locate and discern different sections of the pressure member by feel.

Embodiments of the invention additionally provide mechanisms to give haptic feedback (e.g., the provision of physical feedback which the user can sense by touch and/or feeling) to the user through manipulation of the pressure member and/or knobs. For example, in one embodiment, a knob is configured to cause a vibration, equivalent to a “click” that a user traditionally feels when the knob reaches a new selection such as a new source (e.g., a new media source), mode or media content item. The embodiments are configured to provide other types of such haptic feedback to the user, as well. These features are particularly valuable in automotive applications which seek to reduce distraction of the driver away from driving-related activities.

In addition to the control operations that the user initiates by exerting a force close to where the pressure member is coupled to one of a plurality of switches (e.g., one of four switches located near the corners of the pressure member), embodiments of the invention are configured to detect a force exerted on the pressure member at a distance from a particular one of the plurality of switches (e.g., the user exerting a force closer to the center of the pressure member, at a location of the pressure member in-between two switch locations, etc.). In order to detect such a force, exerted a distance from a switch location, the control circuit identifies the existence of two or more essentially simultaneous switch actuations as having come from the center push or in-between pushes, etc. If the switch actuations occur simultaneously, the control circuit identifies the simultaneous actuations as a center or in-between push. If the switch actuations occur sequentially but within a pre-determined time interval, the control circuit also identifies the switch actuations as a center or in-between push.

According to one embodiment of the invention, the system is configured to treat reception of a user input in the form of the center push or the in-between push as a distinct input (i.e. a different input than the inputs resulting from the forces applied near the switch locations). In one embodiment, the system is configured to interpret the center push or in-between push as a command to operate in either “browse” or “standard” display mode, each of which provides different levels of detail. For example, in a media player operating in the browse display mode, a list of abbreviated media content item identifiers is displayed to the user. For example, in the browse display mode the media content item artist names “Alice Cooper, Alicia Keys, America, Beatles and Billy Joel, etc.” may be displayed to the user. If the user deselects the browse display mode in favor of the standard display mode by initiating a center push, the media player display instead shows a more detailed listing of the selected media content item (e.g., the media content item that is currently playing) including, for example, such information as the name, artist and duration (e.g., The Beatles, Octopus' Garden, 2.45 of 3.59 min.). The browse display and standard display options operate for various modes (e.g., artist, title, album, time, etc.) that are applicable to each of the different sources that may be selectable in a media player.

In addition to the embodiments of the invention using a center or in-between push to select between browse display mode and standard display mode, pressure member forces and pushes can be designated to perform other functions, as well. For example, the pressure member might be configured to change sources when a force is applied to the pressure member (i.e. at a specific location). According to other embodiments, the pressure member may be configured to be a modifier upon application of forces and/or pushes (e.g., much like a “function” key or “shift” key of a computer keyboard) that causes a change in the available selection options of other controls. The pressure member forces and/or pushes can be assignable to other functions, as well.

Embodiments of the invention provide additional mechanisms and methods for accepting user input such as the manipulation of knobs. A knob can be configured to operate as a multiple degree of freedom control. In one example, one degree of freedom of the knob is associated with pressing of the knob; the second degree of freedom is associated with rotation of the knob. Other degrees of freedom for controls are also possible, such as for example, simultaneously pushing and rotating as an alternative form of user input.

According to one embodiment, a first knob configured to operate as a multiple degree of freedom control is used in a media player. The first knob is configured to, as a result of the user pressing the first knob, select the next in a list of sources (e.g., uIndex™ (e.g., uIndex™ is a method and mechanism for identifying media content items that are available from multiple sources thereby providing users with a broader range of media content item options.), AM, FM, Satellite Radio, CD, Hard Drive (HD), uMusic (e.g., A method and mechanism for storing and managing media content. The method and mechanism provides storage facilities for media content items and identifies the media content items by user preference and/or other parameters in order to provide more effective user access of the media content items.) and DVD, etc. The sources may be maintained in any order.

In one example, if a currently-selected source is AM (i.e. AM radio), then by pressing the first knob, the user will cause a media player to switch to FM (i.e. FM radio). By repeatedly pressing the first knob, the user can select any source from a set of source alternatives. In connection with such a user source selection, embodiments of the invention provide visual and/or audible confirmation of the user's selection. In one embodiment of the invention, rotating the first knob performs the traditional operation of controlling media player volume or some other media function.

As the user changes source by pressing the first knob, a displayed color identifies the source selected, for example, red for AM, blue for FM, green for CD, etc. Each time the user presses the first knob to change source, the color changes. Embodiments of the invention provide mechanisms and methods for changing the color of the knob (e.g., by LED's, other light sources, etc.) itself and for changing the color of the display. Identification of the selected source by displaying a color that represents the selected source reduces the level of user attention required. In other embodiments of the invention in which clear or translucent knobs are disposed over a display, alphanumeric, text, or graphic information and/or colors may be displayed through the knob(s) that are associated with source and mode selections. Other information, such as levels and/or progress indications can be displayed near or through the knobs. In addition, an audible cue, such as a “click” played through the audio output of the media player provides notification to the user, even if the user is not looking at the media player at the time of initiating the change. Alternatively, spoken, synthesized, etc. audio feedback may be provided, as well.

A second knob configured as a multiple degree of freedom control is also used to accept user input. By pressing the second knob, the user selects the next mode from a list of modes. Each source has a different subset of modes defined for the individual source. By pressing the second knob, the user can select from among the mode alternatives defined for any source selected by manipulating the first knob.

For example, assume that a user wants to operate the media player by using the hard drive source. First, the user selects the hard drive source by pressing on the first knob as many times as are necessary to select the hard drive source. Each time the user presses the first knob, a new source is selected. Once the hard drive source has been chosen, the user refrains from further pressing of the first knob. Next the user selects from among the four mode options available for the hard drive (i.e. artist, title, album, time) until the desired mode has been selected. For example, if the user wants to display a list of media content items stored on the hard drive in alphabetical order by title, the user presses the second knob until the title display mode has been selected. Upon the user's successful selection of the title display mode, the media player displays the available hard drive media content items in title order. If the user presses the second knob again until the artist mode has been selected, the list of media content items will now be displayed in alphabetical order by artist.

The user, having successfully selected the artist display mode as described above, is then presented with a list of available media content items in alphabetical order by artist, for example, Alice Cooper, Alicia Keys, America, Beatles, Billy Joel, etc. in which the selected/currently playing media content item is highlighted. In an alternative example, if the user selects the title display mode, the list displayed to the user is ordered by title (e.g., How Come You Don't Call Me, Lost in America, Michelle Ma Belle, Piano Man, etc.).

The second knob is configured as a multiple degree of freedom control. Specifically, one degree of freedom of the second knob is associated with pressing the second knob; the second degree of freedom is associated with rotation of the second knob. Therefore, in addition to selecting modes by pressing the second knob, a user can also select media content items from a list of available media content items by rotating the second knob. Accordingly, the user selects the media content item of choice by rotating the second knob until the desired media content item has been selected. The different modes that are selectable by the second knob are capable of displaying media content items in the browse mode or standard mode, as described above.

In one embodiment the system for accepting user input, comprising a plurality of switches and pressure member. The pressure member is coupled to the plurality of switches. The pressure member has multiple sections, wherein each section of the multiple sections is associated with a switch of the plurality of switches. The pressure member is positioned in relation to the plurality of switches such that when the user exerts a force to one of the multiple sections the pressure member transmits a resulting force to a switch associated with the one of the multiple sections. This causes actuation of the switch associated with the one of the multiple sections.

In another embodiment, the system includes a display. The display displays at least one input option and wherein at least one of the multiple sections of the pressure member is spatially associated with the at least one input option displayed.

In another embodiment, at least a portion the pressure member is optically transparent. The pressure member is further positioned in front of the display so that the display is visible through the pressure member. The plurality of switches is further located adjacent to the display and the at least one input option displayed is viewed through the pressure member.

In another embodiment, the system operates in a motor vehicle. In yet another embodiment the system operates as a component of a media system.

In one embodiment one of the multiple sections has a tactile element, wherein the tactile element reduces the requirement for a visual location, by the user, of the at least one of the multiple sections of the pressure member.

In yet another embodiment, the pressure member includes four sections, wherein each section is associated with one of the four switches.

In one embodiment, the pressure member transmits a resulting force to a single switch associated with the one of the multiple sections.

In one embodiment, the pressure member transmits a resulting force to at least two switches associated with the one of the multiple sections.

In another embodiment, the switch actuation initiates a system operation.

In one embodiment, the mechanical characteristics of the pressure member are spatially varied, in order to focus forces exerted upon a selected section of the pressure member to effect a desired switch actuation.

In yet another embodiment, the system comprises a first switch of the plurality of switches, a second switch of the plurality of switches and a control circuit. As a result of the exertion of a force by the user to the pressure member, the pressure member transmits a first resulting force to a first switch associated with one of the multiple sections of the pressure member. The pressure member also transmits a second resulting force to a second switch associated with another of the multiple sections of the pressure member. This causes an actuation of the first switch of the plurality of switches and an actuation of the second switch of the plurality of switches. The control circuit identifies the multiple switch activation as an inferred system state.

In another embodiment, the system comprising a fulcrum that localizes deflection of the pressure member resulting from forces exerted by a user, in order to affect which switches are actuated by the exerted force.

In one embodiment, the system, in response to the exertion of a force on the pressure member by the user, provides confirmation of a user input to the user.

In one embodiment, the system further comprises an indicator light. The indicator light, upon the exertion of a force to the pressure member by the user, is configured to illuminate in order to provide a visual confirmation of the switch actuation to the user.

In yet another embodiment, the system is configured to provide an audible confirmation of the switch actuation to the user. In still another embodiment, the audible confirmation of the switch actuation is a synthetic voice.

In one embodiment, the system for accepting a user input comprises a first control configured to select a media source in response to an actuation of the first control by a user. The system also includes a second control. The second control has two degrees of freedom in actuation, configured to choose a mode from a set of modes for the selected media source in response to an actuation of the first degree of freedom of the second control by the user. The actuation of the second degree of freedom by the user of the second control is configured to identify a media content item selection. A display displays one of the media source, mode and media content item.

In one embodiment, the system for accepting user input comprises a pressure member coupled to the plurality of switches. The pressure member has multiple sections. Each section of the multiple sections is associated with a switch of the plurality of switches. The pressure member is positioned in relation to the plurality of switches such that when a force is applied by a user to one of the multiple sections, the pressure member transmits a resulting force to a switch associated with the one of the multiple sections. Accordingly the switch associated with the one of the multiple sections is actuated.

In one embodiment a control comprises a shaft. The shaft is mounted within a void of the pressure member and secured by a fastener.

In one embodiment, the system delays for a predetermined time, before executing one of a user media source selection, mode selection or media content item selection.

In one embodiment, upon the occurrence of one of a user media source selection, mode selection, or media content item selection, the system provides a sub-menu of options to the user.

In one embodiment, the display is configured to provide a visual confirmation of the media source selected. In yet another embodiment, the display displays a color cue based on a media source selected.

In one embodiment, the display provides a position indicator depicting to the user, the relative position of a selected media content item within a browsable list of media content items. The position indicator is displayed in a radial format.

In another embodiment, the display is a touch screen. The touch screen is configured to process a user input.

In one embodiment, the control is configured to provide a visual confirmation of a user input. In another embodiment, the visual information is text. In yet another embodiment, the visual information is a graphic. In one embodiment, the visual information is a color change.

In yet another embodiment, at least a portion of the control is optically transparent. The control is positioned over the display and information displayed by the display is visible through the control.

In one embodiment, the audible confirmation of the media source selected is a synthetic voice.

In yet another embodiment a second control is positioned in front of the display. The second control accepts actuation of the second degree of freedom by the user, as a user input.

In one embodiment, the system for accepting user input, comprises at least one switch, a display, a pressure member, display and at least one control. The display depicts menu options including media content information and control options. The control options are displayed on the display near the switch. The pressure member is disposed over the display wherein at least a portion of the display is visible through the pressure member. The pressure member is further coupled to the at least one switch such that a resulting force transmitted by the pressure member in response to a user applied force causes a switch actuation. The at least one control is configured to accept one of a push and turn (e.g., first degree of freedom and second degree of freedom) in order to select one of the menu options.

In still another embodiment, at least a portion of the at least one control is optically transparent. The at least one control is positioned over the display. The information displayed by the display is visible through the at least one control.

In one embodiment, the display displays a color to provide user feedback. In another embodiment, the at least one control displays a color to provide user feedback.

In yet another embodiment, the at least one control displays a symbolic representation of a selected one of the media content source, mode or media content item.

In one embodiment a user input comprises a first control. The first control has two degrees of freedom in actuation. Actuation of the second degree of freedom is associated with control of system volume. Actuation of the first degree of freedom is associated with selection of a media source.

The at least one control is disposed over the display and at least a portion of the control is optically transparent such that at least a portion of the display is visible through the at least one control.

In yet another embodiment a media player for use in a motor vehicle comprises a plurality of switches, a display, a pressure member and two controls. The display for displays one of the media source, mode and media content item. The pressure member is coupled to at least one of the plurality of switches. The pressure member is disposed over the display. At least a portion of the display is visible through the pressure member. The pressure member is configured to accept a force exerted by a user within a section of the pressure member. Each of the two controls is located to one side of the display and has two degrees of freedom in actuation.

In still another embodiment, the system displays a set of options on a display to prompt for a user selection. At least a portion of the display is visible through a pressure member, the pressure member being positioned in front of the display. The system generates a switch actuation in response to a force exerted by the user on a section of the pressure member wherein the section of the pressure member corresponds to a desired option. The switch is arranged in an array of switches adjacent to the display. Based on the switch actuation the system changes a system state.

In one embodiment, the system provides a confirmation in response to the exertion of the force to the section of the pressure member by the user.

In yet another embodiment, based on the system state, the system initiates a system operation.

In still another embodiment, the system detects a first switch actuation and a second switch actuation caused by the transmission of a resulting force by the pressure member to the first switch and the second switch. Then the system generates an inferred system state.

In still another embodiment, the inferred system state initiates a browse function.

In yet another embodiment, the system accepts actuation of the first degree of freedom of a first control to select one of the following sources: uIndex, AM, FM, satellite radio, compact disk, hard drive, uMusic, DVD, HVAC/climate, core navigation.

In one embodiment, the system accepts actuation of the first degree of freedom of a second control to select one of the following modes: AM presets, AM seek, AM tune, FM preset, FM seek, FM tune, FM station, FM song, FM genre, FM artist, satellite radio presets, satellite radio station, satellite radio category, satellite radio station, satellite radio song, satellite radio genre, satellite radio artist, CD Track, CD time, CD Disk, CD Artist, CD Song, CD Genre, hard drive title, hard drive track, hard drive artist, hard drive time, hard drive genre, uMusic track, uMusic time, DVD Chapter, HVAC/climate temperature, HVAC/climate fan, core navigation origin, core navigation destination, core navigation directions.

In one embodiment, the system displays a list of options pertinent to the selected mode. The system selects a desired option based on actuation of the first degree of freedom of the second control.

Other features, objects and advantages of the invention will become apparent from the following description when read in connection with the accompanying drawing in which:

### BRIEF DESCRIPTION OF THE SEVERAL VIEWS OF THE DRAWING

The foregoing and other objects, features and advantages of the invention will be apparent from the following more particular description of preferred embodiments of the invention, as illustrated in the accompanying drawings in which like reference characters refer to the same parts throughout the different views. The drawings are not necessarily to scale, emphasis instead being placed upon illustrating the principles of the invention.

FIG. 1 shows a front view of the system for accepting a user input, according to one embodiment of the invention.

FIG. 2 shows a side view of the pressure member assembly, according to one embodiment of the invention.

FIG. 3 shows a side view of the pressure member assembly after the user has applied a force to the pressure member, according to one embodiment of the invention.

FIG. 4 shows an alternative embodiment of the invention employing a fulcrum to focus the force applied to a section of the pressure member, according to one embodiment of the invention.

FIG. 5 depicts a pressure member with raised tactile feedback areas, according to one embodiment of the invention.

FIG. 6 shows two knobs configured to accept a user selection of the content source, mode of operation, and/or specific media content items, according to one embodiment of the invention.

FIG. 7 shows a display displaying a media content item selection in standard mode, according to one embodiment of the invention.

FIG. 8 shows a display displaying a list of available media content items in browse mode, according to one embodiment of the invention.

FIG. 9 demonstrates an assembly of components as described previously with respect to FIGS. 1 through 6, according to one embodiment of the invention.

FIG. 10 depicts a configuration of a knob used to accept user input, according to one embodiments of the invention.

FIG. 11 depicts an alternative configuration of the knob used to accept user input employing a pulley and belt, according to one embodiment of the invention.

FIG. 12 depicts an alternative configuration of a knob used to accept user input employing infra-red detector circuits and a corresponding edge-stripped first knob and/or edge-stripped second knob, according to one embodiment of the invention.

FIG. 13 is a flow chart of a procedure for accepting a user input, according to one embodiment of the invention.

FIG. 14 is a flow chart of a procedure for selecting media according to one embodiment of the invention.

### DETAILED DESCRIPTION

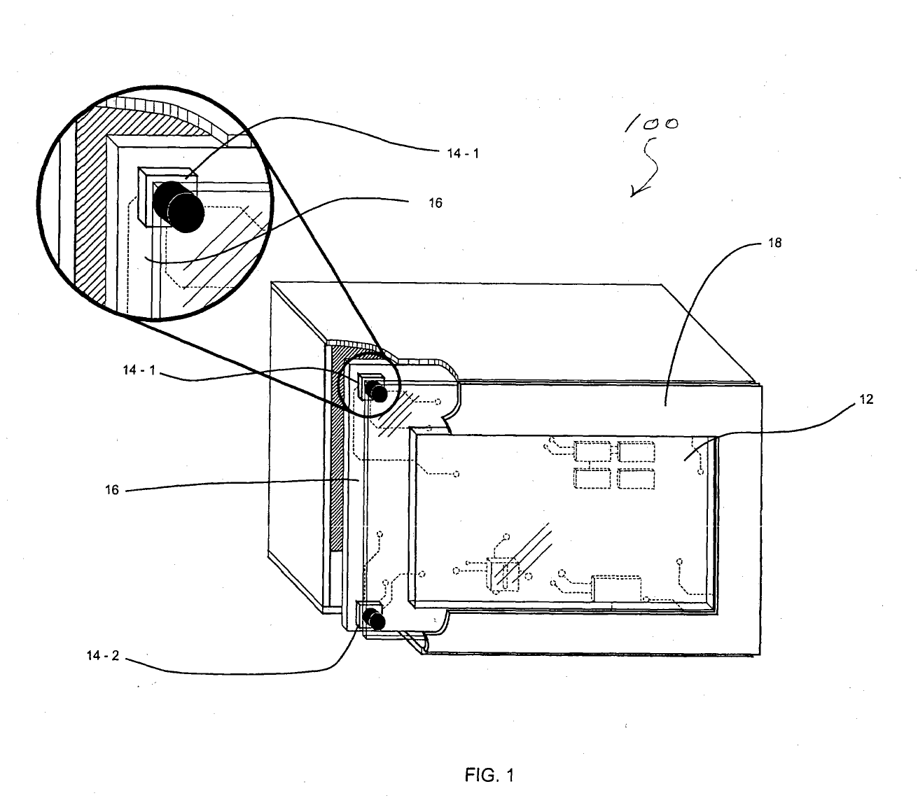

Now, with particular reference to individual drawings, FIG. 1 shows a front view of the system 100 for accepting a user input. The system 100 includes a pressure member 12 (e.g., sheet of plastic or sheet of clear plastic), two switches 14-1, 14-2 (i.e. two switches are shown in cutaway view; the pressure member is also mounted on two additional switches, not shown, located in position behind the two other corners of the pressure member 12), a control circuit 16 and a framework 18.

The pressure member 12 extends to reach a sufficient distance such that the pressure member 12 is positioned over and in contact with the switches 14 (e.g., in this example embodiment, the pressure member 12 extends over four switches positioned at each corner of the pressure member 12). Upon the exertion of a force by the user on the pressure member 12, the pressure member 12 is depressed in the area near the location of one or more switches 14.

In one embodiment, the framework 18 holds the pressure member 12, in position, around the edges of the pressure member 12 such that the pressure member 12 is in the correct position to exert a resulting force on one or more individual switches 14 within a plurality (e.g., an array) of switches. This permits the pressure member 12, in response to a force exerted by a user upon the pressure member 12, to transmit a resulting force to one or more switches 14 that causes actuation of one or more of the switches 14. The switches in the array can be arranged in a variety of different patterns (e.g., spaced evenly, spaced with different distances between switches so as to provide a different sensitivity to resulting forces applied at different locations on the pressure member 12, etc.), according to different embodiments of the invention.

A variety of alternative methods for securing the pressure member 12 are contemplated besides the method of holding the pressure member 12 in position above the switches 14 using a framework 18. Such alternative configurations are considered to be within the spirit and scope of the invention described herein. For example, the pressure member 12 may be attached to a framework 18 or the circuit board 16 by a spring-loaded device that allows for depression of the pressure member 12 against the switch 14. In another example, rather than the framework 18 holding the pressure member 12 in position, the pressure member 12 is permanently positioned by some method of attachment of the pressure member 12 to the switch(s) 14.

The system 100 also includes a control circuit 16, coupled to each of multiple switches 14 in a such a manner that the control circuit 16, based on the switch 14 actuation(s), changes the system state (e.g., parameters, settings, operations performed, functions, data stored in memory locations, etc.). In turn, a media player, an audio system or other controllable device can perform appropriate actions based on the translated system state.

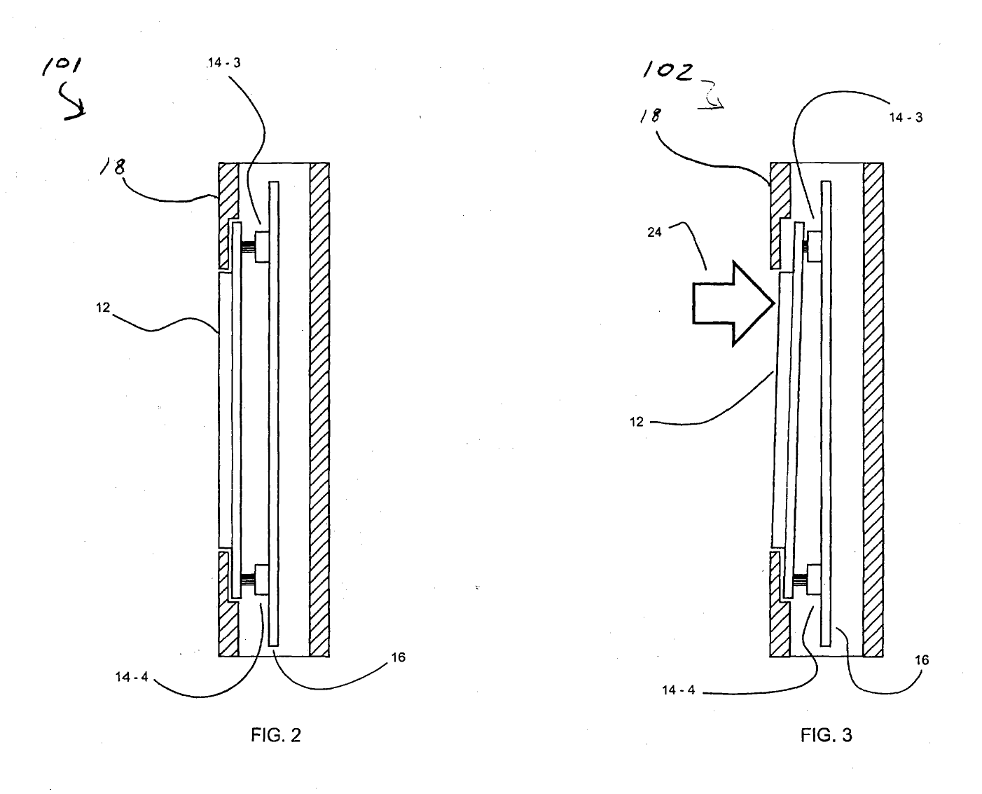

FIG. 2 shows a side view 101 of the pressure member assembly, according to one embodiment of the invention. FIG. 2 shows a side view of the system 100 including the pressure member 12, a framework 18 and two switches 14. The framework 18 holds the pressure member 12 in a position such that by exerting a force against the pressure member 12 a resulting force can be exerted upon the switch 14-3, 14-4 that is located behind the pressure member 12.

FIG. 3 shows a similar side view 102 of the system 100 including the pressure member 12, a framework 18 and two switches 14-3, 14-4. In contrast to FIG. 2, however, in FIG. 3 the user has exerted a force 24 upon the pressure member 12 at a location close to switch 14-3. In response to the exerted force 24, the pressure member 12 transmits a resulting force against the switch 14-3 causing the switch 14-3 to actuate. Accordingly, the user, by exerting a force upon the section of the pressure member 12 nearby to the switch 14-3 associated with a desired control function, effectively selects the desired control function for operation. The control circuit 16 translates the switch 14 actuation occurring in response to the user's applied force into a circuit state for performing the desired control function.

The pressure member 12 may exhibit one or more different responses to the exertion of a force on the pressure member 12, depending upon the configuration of the pressure member 12, the number and locations of switches 14 and/or the configuration of the framework 18 and other components of the system. In one embodiment, exertion of a force on the pressure member 12 results in movement of the end of the pressure member 12 to which the force is being applied in the direction of the nearby switch 14, thereby causing a resulting force to activate the nearby switch 14. However, in an alternative embodiment, a section of the pressure member 12 bends in the direction of the nearby switch 14 such that only a portion of the pressure member 12 causes the resulting force to be exerted against the pressure member 12, in the area of the switch 14 affected. In one such example also, when the user exerts a force on the pressure member 12, the framework 18 holds the portion of the pressure member 12 not exposed to the exerted force from rising too far in the in the direction away from the switch 14 array and/or from falling out of position with respect the array of switches 14. In certain situations, depending upon the location of the force applied to the pressure member 12, more than one switch 14 may be activated.

In addition to the effect of the framework 18 on the movement, bending and other motions of the pressure member 12, fulcrums may also be located beneath the pressure member 12 to localize the effect of forces exerted on the pressure member 12 and the resulting forces that cause switch 14 actuations, such that only limited number of section(s) of the pressure member 12 bend toward and activate switches 14 as a result of the exertion of forces on the pressure member 12 by the user. The use of such fulcrums will be described in more detail later.

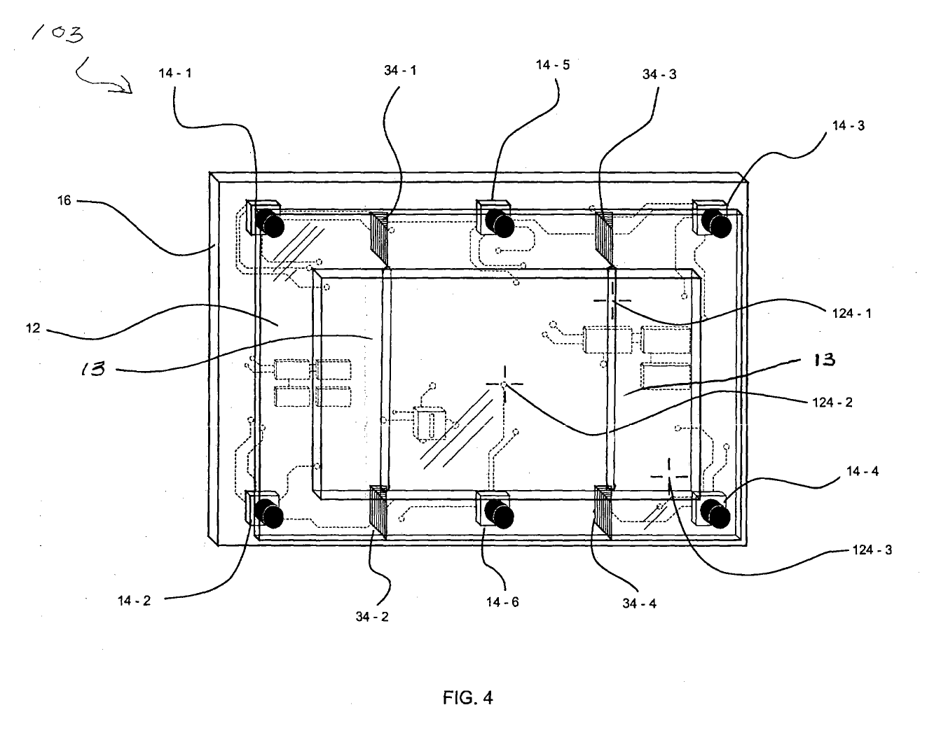

FIG. 4 shows an alternative embodiment 103 of the invention employing a fulcrum to focus the force applied to a section of the pressure member 12 according to one embodiment of the invention. FIG. 4 depicts the system 100 without the framework 18 (i.e. for convenience of demonstration) but including a pressure member 12, four switches 14-1, 14-2, 14-3, 14-4, as described earlier and a control circuit 16. The pressure member 12 has groove(s) 13 (e.g., located near the fulcrum(s)). Grooves are used to modify the local bending stiffness of the pressure member. Grooves may be formed by scoring the surface in a machining operation, or can be effectively formed by molding a part with a different sectional thickness in areas where it is desired to reduce the bending stiffness of the pressure member. In addition, FIG. 4 includes two additional switches 14-5, 14-6 and four fulcrums 34-1, 34-2, 34-3, 34-4. The fulcrums 34-1, 34-2, 34-3 and 34-4 support the pressure member 12 at various positions on the pressure member 12 located between various pairs of switches 14-1, 14-5; 14-2, 14-6; 14-3, 14-5; 14-4, 14-6 which are located at the ends and center of the pressure member 12. For example, fulcrum 34-3 provides physical support to the pressure element 12 at a position that is located between center-located switch 14-5 and corner-located switch 14-3. The fulcrums 34 focus the user forces, exerted on the pressure member 12, to increase the likelihood of desired switch 14 actuations.

In one example, a force exerted on the pressure member near the fulcrum location 124-1 will not be transmitted to the end switch 14-3 due to the support provided by the nearby fulcrum 34-3. Accordingly, such a fulcrum reduces the likelihood that a user force, exerted in the area of the fulcrum 34-3, would cause switch actuation.

Conversely, in an alternative example, depicted in FIG. 4, the force 124-2 exerted against the pressure member 12 at a position closer to the center switches 14-5, 14-6 and away from the fulcrum 34-3 causes switch 14-5 and 14-6 actuations. Force 124-2 is less likely to result in a deflection of the pressure member in the vicinity of switches 14-3, 14-4, 14-1, or 14-2, due to the action of fulcrums 34. Force 124-2 causes the middle section of pressure member 12 to be deflected inward. Grooves 13 facilitate the bending of pressure member to allow this deflection, and the fulcrums cause the inward directed force 124-2 to cause outward deflection of the outside sections of pressure member 12, away from switches 14-1, 14-2, 14-3, and 14-4. Equivalently, the force 124-3 exerted against the pressure member 12 at a position closer to the corner switch 14-4 causes actuation of the corner switch 14-4, and does not affect other switches. These examples demonstrate the way in which fulcrums 34, and fulcrums in combination with local variations in bending stiffness of the pressure member, focus forces on the pressure member 12 in a manner that reduces the likelihood of unintended switch 14 actuations.

According to one embodiment of the invention, the shape, geometry, and physical properties of the pressure member 12 may be designed in such a manner as to appropriately focus the movement and/or bending behavior of the pressure member 12 and, in turn, the resulting force exerted by the pressure member 12 on the switches 14. Grooves 13 in the pressure member 12 provide the appropriate variation in the bending stiffness of the pressure member 12 so that a user force, exerted in the appropriate section of the pressure member 12 causes the pressure member 12 to bend and generate desired switch 14 actuations. Scores, notches, bevels, thinning or other modifications of the pressure member 12, etc. may alternatively be added to provide such desired directional control.

The system is capable of differentiating between the application of forces to the pressure member in the vicinity of individual switches from the application of forces to the pressure member spaced away from individual switches. In order to detect a force exerted on the pressure member 12 by the user in a location other than near a switch 14, the control circuit 16 identifies the existence of two or more switch 14 actuations as having come from such a center push or in-between push, etc., rather than having been generated by the user exerting the force to the pressure member 12 near one of the switches (e.g., near switches 14-1, 14-2, 14-3, 14-4 located at corners of the pressure member 12). Note that the use of fulcrums can modify the number of switches that may be activated due to the application of a force. For example, force 124-1 does not result in a switch activation due to the presence of fulcrums 34-3 and 34-4. If these fulcrums were not present, force 124-1 could result in as many as 4 switch activations. After the control circuit 16 detects any multiple switch 14 actuation, the control circuit 16 translates the multiple switch 14 actuations into a circuit state for performing a desired control function. Also, such multiple switch 14 actuations may occur sequentially rather than simultaneously.

One method for detecting multiple switch actuations is the following. The method identifies essentially simultaneously switch 14 actuations, that is, switch 14 actuations that are either simultaneous or which occur within a short, predetermined time interval.
1. Switch 14 states from all switches 14 are logically OR'ed by the control circuit 16 to create a single actuation state. Accordingly, actuation of any switch 14 results in a single actuation state.
2. In response to a single actuation state, the control circuit 16 samples the state of each switch 14 to determine which switch 14 has been actuated.
3. The control circuit 16 enables a timer to monitor a switch 14 debounce period. The switch 14 debounce period is an elapsed time period during which any additional single actuation states are ignored. The debounce period is an adjustable parameter stored in memory which is used by the software performing the detection of multiple switch actuations.
4. During this debounce period the control circuit 16 tests individual switch 14 states to identify multiple switch 14 actuations. Switch 14 states of any more than two switches 14 occurring during the debounce period represent simultaneous switch 14 actuations.
5. After the debounce period expires, if a single switch 14 state was detected, the control circuit 16 identifies a switch 14 identification of the switch 14 experiencing the switch 14 state; if multiple switch 14 states were detected, the control circuit 16 identifies the existence of the center push or in-between push.

According to one embodiment of the invention, the system is configured to treat reception of a user input in the form of the center push or the in-between push as a distinct input (i.e. a separate input from those resulting from forces applied near the switch locations). In one embodiment, the system is configured to interpret the center push or in-between push as a command for a media player to operate in either “browse” or “standard” display mode. Details of the browse and standard display mode will be provided later.

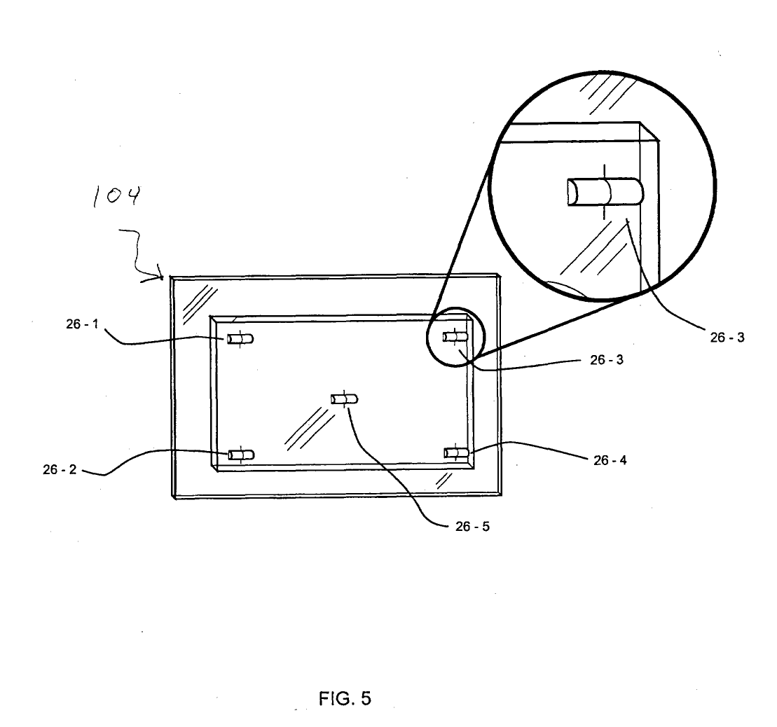

FIG. 5 depicts a pressure member 104 (e.g., 12) with raised tactile feedback areas 26 (e.g., tactile elements), according to one embodiment of the invention. The “tactile element” (e.g., raised tactile feedback areas 26) provide the user with tactile feedback area 26 location points on the pressure member 12 for finding a desired section of the pressure member 12 at which to exert a force 24. Accordingly, the user can identify the tactile feedback areas 26 by feel, thus reducing the need to look at the pressure member 12. The location of the tactile feedback areas 26 may also be configured such that the tactile feedback areas' 26 location(s) on the pressure member 12 identify the optimal points for the user to exert the force 24 within any section of the pressure member 12. In other words, the tactile feedback areas 26 identify the location(s) at which the exertion of the user force 24 (i.e. to the pressure member 12) most effectively focuses the resulting force to activate an appropriate switch 14 or combination of switches 14 thereof.

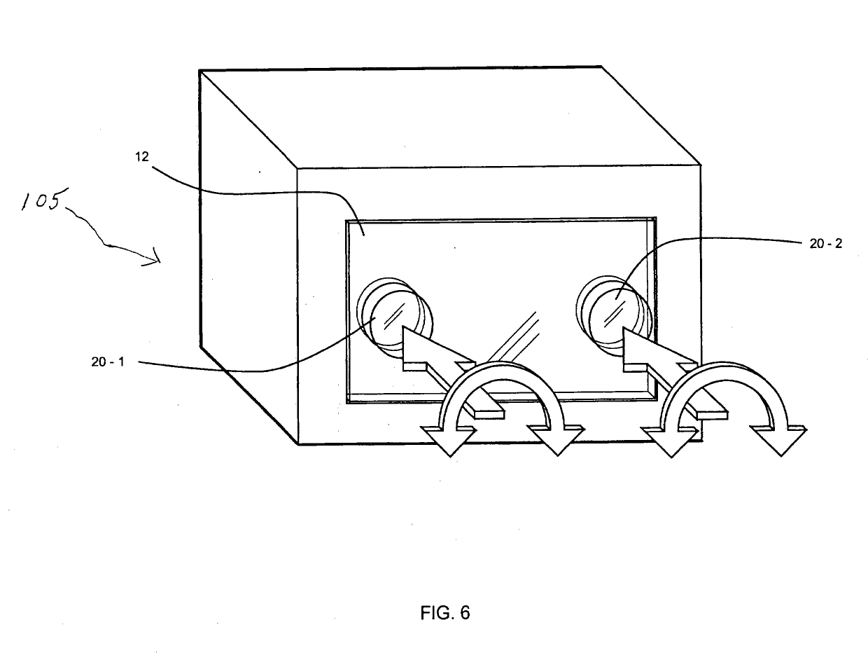

FIG. 6 shows two knobs 105 configured to accept a user selection of the source, mode of operation (e.g., in the case of a media player), and/or media content items, according to one embodiment of the invention. The figure includes the pressure member 12, the first knob 20-1 and the second knob 20-2. The first knob 20-1 and the second knob 20-2 may be mounted in different locations and/or ways according to different embodiments of the invention. According to one embodiment, the first knob 20-1 and the second knob 20-2 are mounted on the pressure member 12, itself. In other embodiments the first knob 20-1 and the second knob 20-2 are mounted on a circuit board positioned beneath the pressure member 12. The first knob 20-1 and second knob 20-2 accept user inputs in the form of pressing and/or rotating either knob 20. Such first knobs 20-1 and second knobs 20-2 can be conventional push/rotate analog or digital controls with knobs 20 attached to control shafts, appropriately configured for use as part of the invention, other control mechanisms providing the same control inputs or knobs 20 with mechanisms as described below.

Embodiments of the invention provide additional mechanisms and methods for accepting user input such as the manipulation of knobs 20. A knob 20 is configured to provide control based on two degrees of freedom of the knob 20. In one example, one degree of freedom of the knob 20 is based on the user pressing the knob 20; the second degree of freedom of the knob 20 is based on the user rotating the second knob.

In one embodiment, a colored light source, alphanumeric or graphic display is positioned beneath either of the first knob 20-1 and/or second knob 20-2 for the display of color cues through the first knob 20-1 and/or second knob 20-2 for observation by the user. Pressing of the first and second knobs 20 results in selecting different items that are configured to be selectable by the knobs 20, where colors visible through the first knob 20-1 and second knob 20-2 are changed according to the items selected

In one embodiment of a media player, the first knob 20-1 is configured to, as a result of the user pressing the first knob 20-1, select the next source from a sequence of sources. For example, with respect to a list including sources uIndex™, AM, FM, Satellite Radio, CD, HD uMusic, DVD, etc. (e.g., in any order) if a currently selected source is AM (i.e. AM radio), by pressing the first knob 20-1, the user will cause the media player to switch to FM (i.e. FM radio), as described earlier. When the user changes source by pressing the first knob 20-1, a displayed color (e.g., color of the first knob 20-1, LCD display, or any other particular visual display associated with the media player, etc.) identifies the source selected, for example, red for AM, blue for FM, green for CD's (i.e. compact disks). Each time the user presses the first knob 20-1 to change source, the color of the first knob 20-1 changes.

The second knob 20-2 is also configured to accept user input. In response to the user pressing the second knob 20-2, the second knob 20-2 causes the next mode from a sequence of available modes to be operational. Mode selection for the second knob 20-2 is based on a subset of available modes specific to each particular media content source. In other words, the second knob 20-2 is configured such that by pressing the second knob 20-2, the user selects among the mode alternatives defined for whatever source the user selected by the user's manipulation of the first knob 20-1.

As described earlier with respect to the first knob 20-1, operation of the second knob 20-2, in one embodiment, also incorporates providing audible and visual cues to confirm user selections to the user. In particular, with respect to the color coding displayed either on the display or transmitted through the second knob 20-2, one color scheme is to display different; colors to represent modes of operation associated with the second knob 20-2. An alternative color scheme uses different shades of the color displayed in association with first knob 20-1 source selections to depict the second knob 20-2 modes selected. Other color schemes and audible and/or visual cues are also feasible.

Finally, the second knob 20-2 is configured to also select a desired media content item from among multiple media content items in a list of available media content items. Accordingly, in response to the user selecting a particular mode, the second knob 20-2 is configured such that rotating second knob 20-2 causes the media player to successively select different individual media content items from the available media content items. In one embodiment of the invention, the second knob is positioned in front of the display and the second knob accepts rotation by the user as a user input.

The sequence order of the media content item selections depends upon the mode selected (e.g., song, artist, genre, etc. order), as described later in more detail.

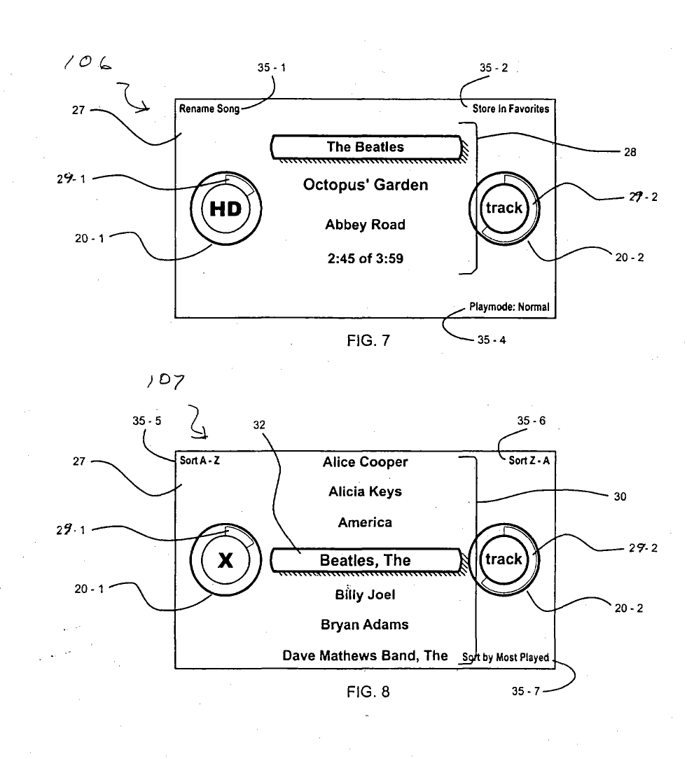

FIG. 7 shows a display 106 (e.g., 27) displaying a media content item selection 28 in standard model according to one embodiment of the invention. The figure includes a first knob 20-1 and second knob 20-2, options 35-1, 35-2, 35-4, a media content item selection 28 and a radial scroll bar 29. The first knob 20-1 and second knob 20-2 accept user inputs, as described above with respect to FIG. 6.

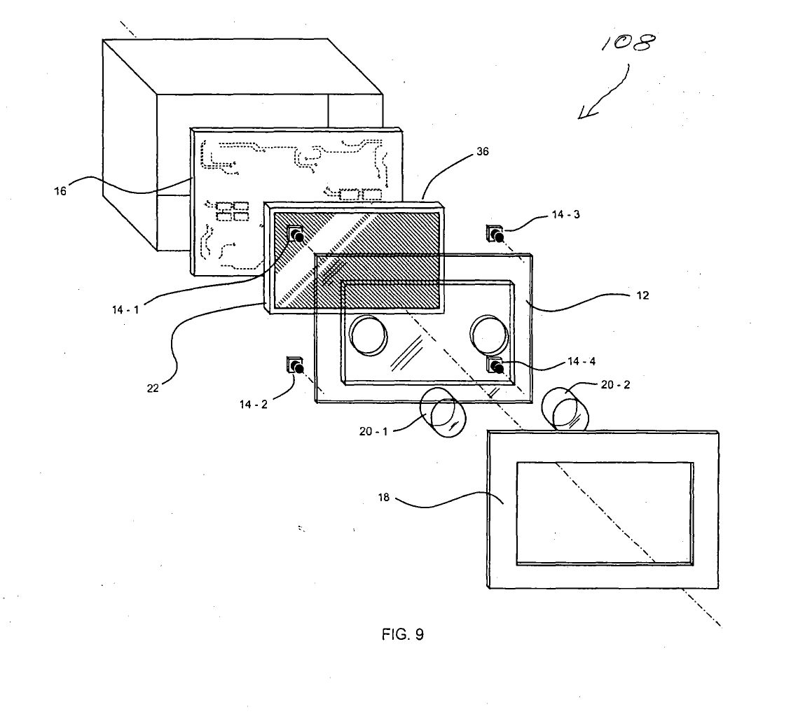

FIG. 7 depicts an alternative embodiment of the invention in which a clear or translucent first knob 20-1 and/or second knob 20-2 provide a visual cue with respect to the source and/or mode selected. For example, the first knob 20-1 may show the hard disk source as having been selected or alternatively show additional command options such as “X” (See FIG. 8) for “cancel” or “escape”, or to display options such as selections/commands used as submenu options. In one such embodiment, the knobs 20 are mounted in front of the display such that letters displayed on the display screen are projected through the first knob 20-1 and/or second knob 20-2, as depicted with respect to the first knob 20-1. For example, the display 16 shows that the “hard drive” is the selected source and that, as depicted with respect to the second knob 20-2, the selected mode is “track”.

In addition, the display 27 displays options 35-1, 35-2, 35-4 (e.g., that project through a transparent pressure member 12) that coincide with available options for the selected source (e.g., hard disk, as depicted in FIG. 7). Notably, the display options 35-1, 35-2, 35-4 are spatially associated with the switches 14 that operate the options 35. The options are displayed such that when a user exerts a force on the pressure member 12 near the option 35, the switch 14 actuation resulting from the exertion of the force causes a system state to change that is related to the displayed option 35. Exemplary options include: for uIndex™ Mode: search by song, reset search, search by artist, search by genre; for AM: add to presets; for FM: RDS Options, add to presets, continuous play; for satellite radio: add to presets, continuous play; for CD: name current, store CD, eject, play mode-current; for HD: rename song, store in favorites, play mode-current; for uMusic: plus more songs like this, minus less songs like this; for DVD audio track, subtitle, eject, display.

According to one embodiment of the invention, the first knob and/or second knob are configured to accept alternative sets of command options, such as options for mode selections and for sub-selections (e.g., sub-menus). The second set of alternatives (i.e. the sub-selections or sub-menus, etc.) may be automatically made available to the user after a pre-determined period of time, or the set of alternatives may be activated by a selection such as a pressure member 12 input, such as a fixed button, or other control, etc.

For example, in one embodiment, when a user wants to select a mode, the user first selects the mode (e.g., such as the title mode) by pressing the second knob 20-2 until the title mode is selected. After 5 seconds, the system 100 automatically displays a sub-menu of title mode options such as: “sort a-z”, “sort z-a”, “sort by most played”. In one such embodiment, the sub-menu of mode options is displayed from in the main display 28; alternatively, the sub-menu of mode options may be displayed as a set of pressure member 12 usable menu options. According to yet other embodiments, such a sub-menu of mode options may be selected by pressing a fixed button or other control device.

In another example, having selected an artist from a list of artists depicted in browse mode, multiple songs may, in the case of a popular artist, have been selected for the artist in question. Accordingly the system 100 provides the user with sub-menu options such as “by album”, “by track”, etc. by which the user can select specific media content item selections (e.g., “by album”, “by track”, etc.) from the list of available media content items for the previously-selected artist. Other such sub-menu option selections are also possible (e.g., source, mode, other commands, etc. sub-menu selections). As described earlier, in one embodiment, the system 100 is configured to automatically present the sub-menu options to the user after a predetermined elapsed time (e.g., 5 seconds). Alternatively a different user input device (e.g., such as a separate “touch screen”, pressure member 12 or other user selection mechanism) may be provided to initiate presentation of the sub-menu options to the user.

According to one embodiment of the invention, upon selection of a source (e.g., by pressing the first knob 20-1 until the desired source has been selected), a mode (e.g., by pressing the second knob 20-2 until the desired mode has been selected) or a media content item (e.g., by rotating the second knob 20-2 until the desired media content item has been selected), the system 100 delays execution of the selection made until a predetermined time has elapsed. This avoids the problem of jumping from source to source, mode to mode or from performing multiple media content items as the first knob 20-1 or second knob 20-2 is being repeatedly pressed or scrolled.

The media player display also shows a detailed or standard display 16 mode listing 28 of the selected media content item (e.g., the media content item that is playing) including, for example, such information as the name, artist and duration (e.g., The Beatles, Octopus' Garden, 2.45 of 3.59 min.).

Finally, the radial scroll bar 29-1, 29-2 provides a position indicator of a selection from the lists of sources, modes, content items, etc. by displaying, to the user, the relative position in such lists of the selected source, mode, or content item, etc.

FIG. 8. shows a display 107 (e.g., 27) displaying a list 30 of available media content items in browse display mode, according to one embodiment of the invention. The figure includes a first knob 20-1 and second knob 20-2, options 35-5, 35-6, 35-7, analogous to those described with respect to FIG. 7 and a list of available media content items 30. The list 30 of available media content items includes entries representing available media content items listed sequentially (i.e. in “artist mode” i.e. alphabetical order by artist), including media content items sequentially prior and subsequent to the selected media content item 32.

According to one embodiment of the invention, the system 100 is configured to treat reception of a user input in the form of the center push or the in-between push as a distinct input (i.e. a distinct input from the inputs resulting from forces exerted on the pressure member 12 near the switch locations). In one embodiment, the system 100 is configured to interpret the center push or in-between push as a command for the media player to change operation between “browse” or “standard” display mode. In the browse display mode, a list of abbreviated media content item identifiers 30 is displayed to the user. For example, in the browse display mode the media content item artist names “Alice Cooper, Alicia Keys, America, Beatles and Billy Joel, etc.” may be displayed to the user. If the user deselects the browse display mode in favor of the standard display mode by initiating a center push, the media player display instead shows more detailed information (See FIG. 7, 28) about the selected media content item 32 (e.g., the media content item that is playing) including, for example, such information as the name, artist and duration (e.g., The Beatles, Octopus' Garden, 2.45 of 3.59 min.). The browse display and standard display options operate within various source modes (e.g., artist, title, album, time, etc.).

In addition to the embodiments of the invention using a center or in-between push to select between browse and standard display mode, pressure member 12 forces and pushes can be designated to perform other functions, as well. For example, in one embodiment, the pressure member 12 is configured such that forces and/or pushes exerted on the pressure member 12 perform operations that were otherwise performed by knob 20 push operations as described below with respect to a first knob 20-1 and second knob 20-1. According to other embodiments, the center push and/or in-between pushes may be configured to be treated as a modifier that causes a change in the available options of other controls (e.g., one or more of the knobs 20) in much the same way as a function or shift key operates on a computer keyboard. The pressure member 12 forces and/or pushes can be designated to other uses, as well.

FIG. 9 demonstrates an assembly of components 108 as described previously with respect to FIGS. 1 through 6, according to one embodiment of the invention.

FIG. 9 includes the control circuit 16, the display 36, the switches 14-1, 14-2, 14-3, 14-4, the pressure member 12, the first knob 20-1, the second knob 20-2 and the framework 18 combined in one physical unit. In this configuration, the control circuit 16 is mounted in the same enclosure as other components of the system 100. The control circuit 16 can be provided in various configurations including, among others, being mounted as a separate component of the system 100, being mounted in other locations such as in a separate enclosure, as part of a cable or other component, or performed as software functions on a computer, etc. The display 36, in this configuration, is mounted behind the pressure member 12. Accordingly, the pressure member 12 provides a protective shield for the display 36 (such as a fragile LCD display).

Alternatively, the display 36 could be mounted independently of the other components, such as in a separate location (e.g., mounted above the pressure member 12 such that options 35 displayed still show a spatial correspondence to the switches 14 that control the control functions). The display 36 could be mounted in other places, as well.

The pressure member 12, is located such that switches 14 are coupled to the pressure member 12. The switches 14 can be activated by a resulting force exerted upon the switch or switches 14 in response to the exertion of a force by the user upon the pressure member 12. First knobs 20-1 and second knobs 20-2 may be mounted on the pressure member 12 or through holes/voids in the pressure member 12, as described above or in other alternative locations and ways. In one embodiment, the knob(s) 20 fit into a hole/void(s) in the pressure member 12 and the knob(s) 20 is held in place in the pressure member 12 by a pressure pin or other similar device. The framework 18 is mounted in such a fashion that it holds the pressure member 12 in place with respect to the location of the switches.

Although FIG. 9 depicts a configuration of the invention combining the pressure members and knobs along with the display operating within the same physical device, alternative configurations employing individual components are also feasible. For example, one embodiment may only include the pressure member 12 mounted on switches 14 capable of accepting user input by pressing the pressure member 12. Alternatively, in another configuration, only the first knob 20-1 and/or second knob 20-2 are provided in order to provide those features corresponding to the knobs. Various other embodiments of the invention, based on alternative combinations of the components described herein, are also contemplated as being within the scope of the invention.

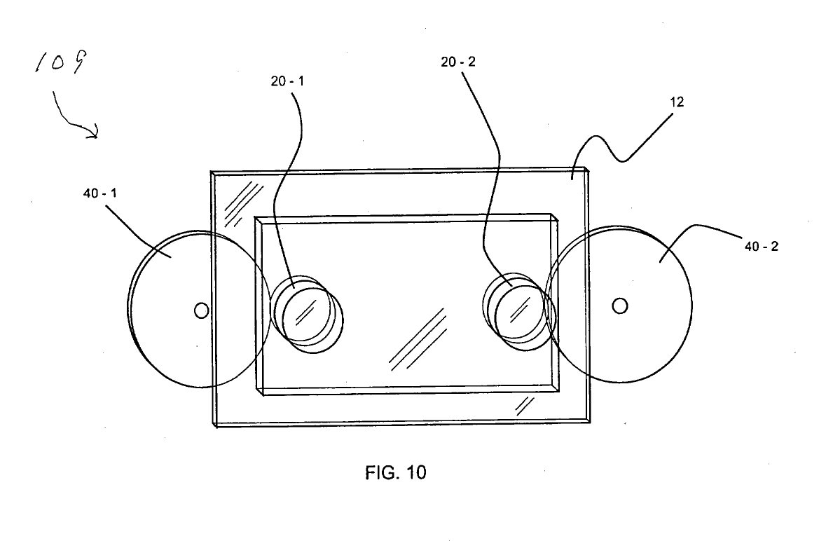

FIGS. 10, 11 and 12 depict alternative configurations (i.e. 109, 110, 111) of the knobs 14 used to accept user input, according to various embodiments of the invention. In particular, the three embodiments depicted provide mechanisms for accepting a user input that do not interfere with the line of sight for color or other cues (e.g., alphanumeric display) that shine through the back of either the first knob 20-1 and/or the second knob 20-2 for viewing by the user. In certain configurations, the pressure member 12 may be opaque in the location in front of the mechanisms, so as to hide the mechanisms from the view of the user. One embodiment of the invention comprises one or more transparent knobs 20 positioned over the pressure member 12 and the display 27 in such a manner that the user can observe selection options on the display 27 in order to make user selections by rotating a knob 20 (e.g., first knob 20-1 or second knob 20-2) and/or by pushing the pressure member 12.

FIG. 10 includes a first drive gear 40-1 for the first knob 20-1 and a second drive gear 40-2 for the second knob 20-2. Each drive gear 40 is driveably coupled to the corresponding knob 20 (e.g., gear coupling, friction coupling, belt, etc.) such that rotating the first knob 20-1 and/or the second knob 20-2 causes rotating in each respective drive gear 40, that in turn operates a rotary control (e.g., a potentiometer, rotary digital encoder, etc.) mechanism of the media player or other controllable device.

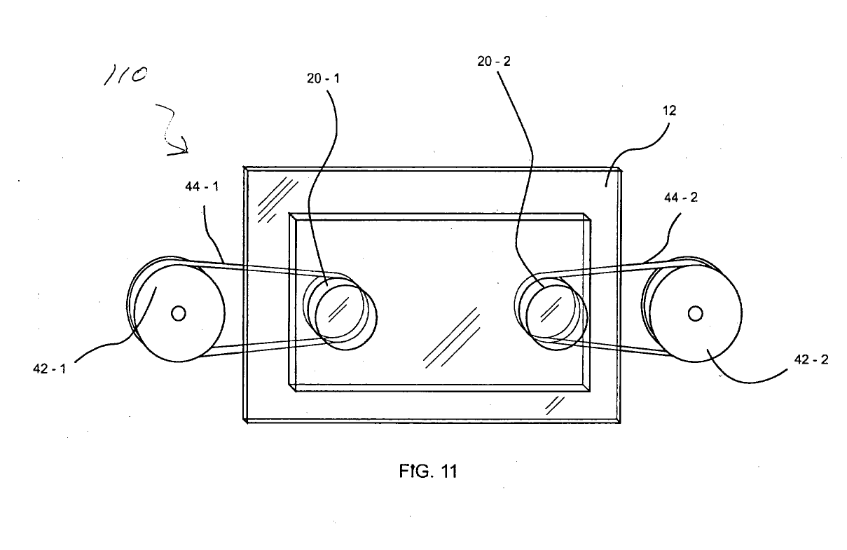

FIG. 11 depicts an alternative arrangement using a pulley 42 and belt 44 according to one embodiment of the invention. Each pulley 42 is driveably coupled via the belt 44 to the corresponding knob 20. In turn, the pulley 42 operates a rotary control (e.g., a potentiometer, rotary digital encoder, etc.) mechanism of the system 100.

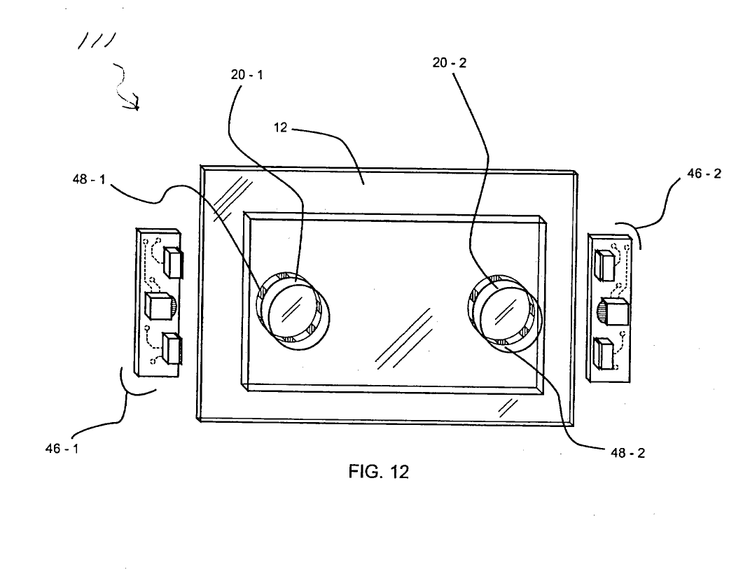

FIG. 12 depicts an arrangement using infra-red detector circuits 46 and corresponding edge-striped knobs 20. According to the embodiment depicted in FIG. 12, the infra-red detectors detect changing infra-red light reflected from stripes on the first knob 20-1 and/or the second knob 20-2. In turn, the control circuit 16 converts a signal created by the infra-red detector circuits into control signals (e.g., to change a system state) to control the system 100. The benefit to this arrangement is that no mechanisms for coupling knobs to control devices are visible to the user, or cover sections of the display.

Each drive mechanism described in FIGS. 10, 11, 12 (i.e. gear drive 40, pulley 42 and/or infrared detector circuit 46) is positioned near the outside edge of the pressure member 12. Accordingly, the rear side of the first knob 20-1 and/or second knob 20-2 are left free from obstruction for the transmission of light and/or color through the first knob 20-1 and/or second knob 20-2. Accordingly, in one embodiment of the invention a light source projects colored light through a clear or translucent first knob 20-1 and/or second knob 20-2 in order to provide a visual cue with respect to the source and/or mode selected, as described earlier.

Having described the system 100 for accepting user input, the following describes a procedure for accepting user input.

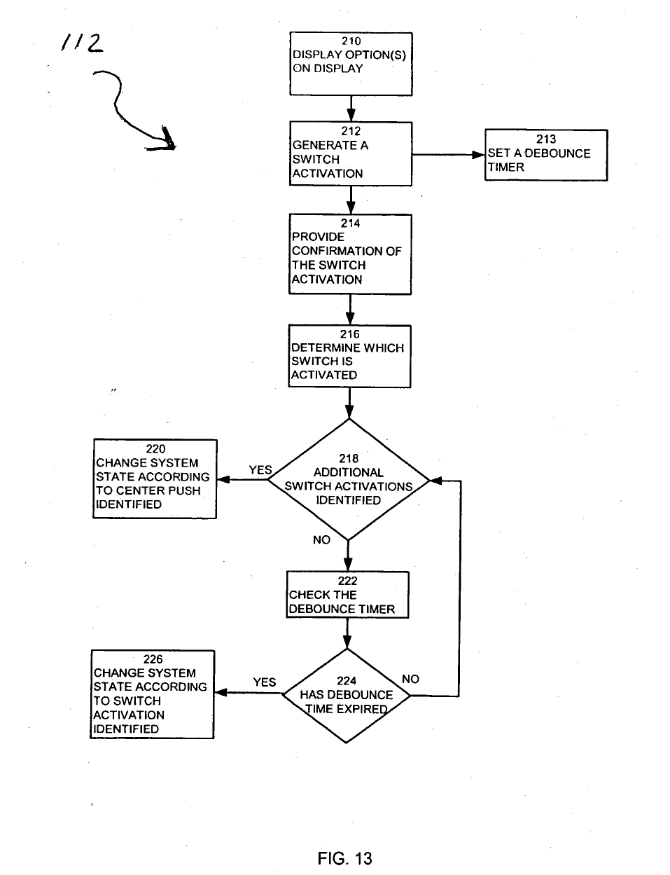

FIG. 13 is a flow chart 112 of a procedure for accepting a user input, according to one embodiment of the invention.

In step 210, the system 100 displays a set of menu options on a display 16 to prompt for a user selection. Various different mechanisms for displaying the set of options are feasible. For example, such display mechanisms may include video and cathode ray tube (CRT) monitors, liquid crystal display (LCD), plasma display, digital read out devices, etc. mounted behind the pressure member 12, in a nearby location, or elsewhere.

In step 212, the system 100 detects a switch 14 actuation, in response to a force 24 exerted by the user on a section of the pressure member 12. Sections of the pressure member 12 are associated with menu options from the set of options displayed in step 210. The media player uses the switch 14 actuation to enact the user's desired activity (e.g., selection of a particular media content item, enacting a system command, etc.). The switch 14 actuation is the switch 14 actuation caused by the user's choice of the section of the pressure member 12 on which the user exerts a force.

The multiple (e.g., array) of switches 14 are coupled to the pressure member 12 so that one or more of the switches 14 are able to be activated depending upon which section of the pressure member 12 the user exerts a force. For example, assume that menu option one is “Rename Song” and menu option two is the “Store in Favorites”. The user can select “Store in Favorites”, for example, by exerting a force to a section of the pressure member 12 associated with (i.e. near, in an analogous position, etc.) the switch 14-3 that translates the switch 14-3 actuation to a system state. The system state, in turn, causes performance of a function defined by menu option 2 (e.g., “Store in Favorites”.

In step 213, the control circuit 16 sets a debounce timer, used to measure an elapsed time period starting from the time of the first switch 14 actuation for a predetermined debounce period. The debounce period is an adjustable parameter stored in memory, during which period any additional switch 14 actuations will be considered to have been part of a multiple switch 14 actuation. During the debounce period, the control circuit 16 tests individual switch 14 states to identify multiple switch 14 actuations.

In step 214, the control circuit 16 provides a confirmation (audible, visual, tactile, as well as changes in color, etc.) in response to the exertion of the force to the section of the pressure member 12, by the user. For example, in one embodiment, the system plays a familiar “click” to confirm the switch 20 actuation, in response to the user input

In step 216, the control circuit 16 determines which switch 14 has been activated.

In step 218, the control circuit 16 continues to periodically test switches 14 in order to determine which additional switches 14 are activated, if any. The control circuit 16 continues checking for additional switch 14 actuations (See steps 222, 224) until the expiration of the debounce time period.

In step 220, if the control circuit 16 has detected multiple switch actuations, the system state is changed according to the identified center push. If multiple switch activations have not been detected, the system proceeds to step 222.

In step 222, the control circuit 16 checks the elapsed time remaining on the debounce timer. Step 222 and the step of checking to see if the debounce timer has expired (i.e. step 224) are repeated until the debounce timer expires. Once the debounce timer has expired (e.g., without the occurrence of additional switch 14 actuations) the control circuit 16 determines that only one single switch 14 actuation has occurred. Accordingly, in step 226, the control circuit 16, changes the system state in accordance with the single switch actuation detected. In turn, the media player or controllable device uses the system state as the basis for conducting a control operation.

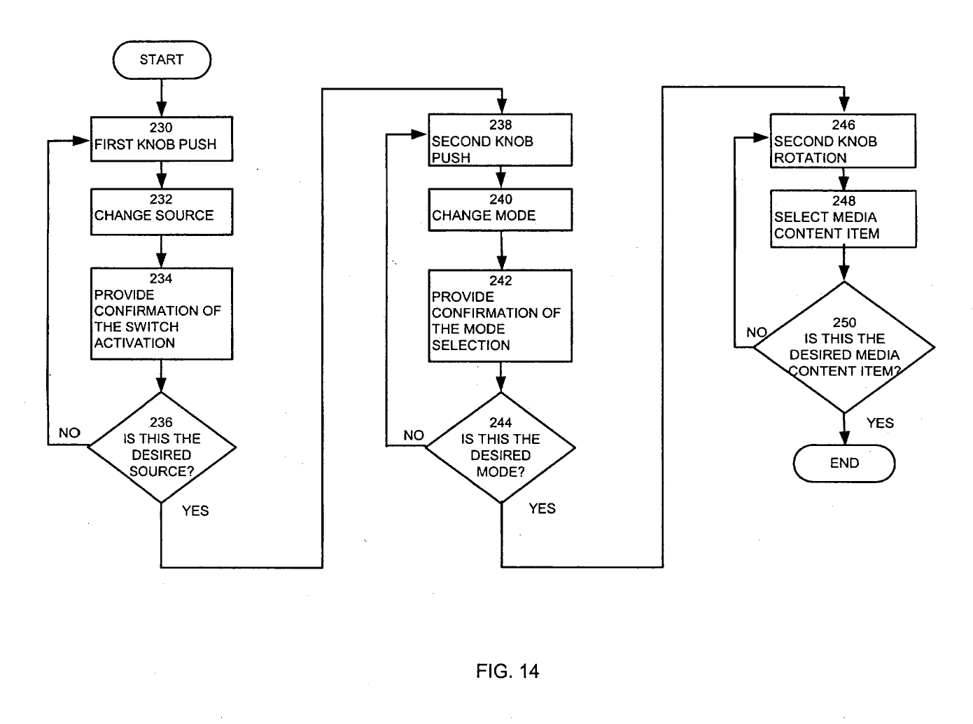

FIG. 14 is a flow chart 113 of a procedure for operating a media player according to one embodiment of the invention. The procedure describes the process of first selecting a source then selecting the appropriate mode of operation of the media player followed by the user selecting the desired content item.

In step 230, the system 100 detects the first knob 20-1 push (i.e. second degree of freedom) by the user in order to select a source of the media player. The system 100 detects repeated user presses of the first knob 20-1 thereby cycling to subsequent next sources in a sequence, namely: uIndex™, AM radio, FM radio, satellite radio, compact disk, hard drive, uMusic, digital video disk (DVD), etc.

In step 232, the source is changed. For example, the first knob 20-1 push may switch from the uIndex™ source to the AM radio source. Upon pressing the first knob 20-1, the source may immediately switch to the newly selected source (i.e. AM) and the media player begins to provide media content from the new source. According to another embodiment, there is a delay from the time that the user pushed the first knob 20-1 (e.g., thereby selecting the next source in a sequence) to the time that the system 100 starts playing media content from the new source which reduces the effect of thrashing through multiple sources in succession.

In step 234, confirmation to the user of the change is made and the display is updated. The system 100 provides visual and/or auditory confirmation of the source selected such as displaying colors from the first knob 20-1, from the display 27, playing an audible click, etc. as described earlier.

In step 236, the system 100 determines if the desired source has been selected. The user moves on to select mode the (See Step 238). If the correct source hasn't been selected step 230-234 are repeated.

In step 238, the system 100 detects the second knob user press (i.e. first degree of freedom) selecting from among the available modes for the current source (i.e. the source selected by the first knob 20-1 press) including: uSearch mode(s): select letter; AM radio modes: seek, tune, presets; FM radio modes: seek, tune, station, presets, artist, song, genre; satellite radio modes: station, presets, artist, song, genre/category; compact disks modes: genre, artist, song, track, time (fast forward/rewind); hard disk modes: artist, song, album, time (fast forwarding/rewind); uMusic modes: track, time (fast forward/read write); DVD mode: chapter.

In step 240, the mode is changed.

In step 242, the system 100 provides visual and/or auditory confirmation of the mode selected such as displaying appropriate colors from the second knob 20-2, from the display 27, displaying different shades of the color used to confirm source selections on either the second knob 20-2 and/or the display 27, etc.

In step 244, if the correct mode has been selected, the user continues to the next step. If the correct mode has not been selected, steps 238-242 are repeated until the correct mode is selected.

In step 246, the system detects a second knob rotation to select a media content item.

In step 248, the system 100 selects a desired media content item from among multiple media content items in a list of available media content items. The selected item is displayed, and the system may begin playing the item. According to one embodiment, there is a delay from the time that the user selects the media content item to the time that the system 100 starts playing the media content which reduces the effect of thrashing through multiple media content items in succession.

In step 250, if the desired media content item has been selected, the process ends. If the desired media content item has not been selected, the user repeats steps 246-248 until the desired item has been selected.

Thus, as described in detail above, embodiments of the invention provide a system and method for accepting a user input.

While this invention has been particularly shown and described with references to preferred embodiments thereof, it will be understood by those skilled in the art that various changes in form and details may be made therein without departing from the spirit and scope of the invention, as defined by the appended claims. For example, embodiments of the invention may be applied to media systems. Embodiments of the invention may also be applied to automotive systems. The embodiments of the invention described herein, may also applied to a variety of control application settings, as well.

With respect to the different components of embodiments of the invention described herein, the display 16 may be integrated with the pressure member 12 in a single arrangement; in other embodiments of the invention the display 16 and pressure member 12 arrangement may be separate. Also, certain embodiments of the invention, as described herein, may partly incorporate traditional touch screen technology and push-button switch, etc. technology, in place of the pressure member 12-based user touch capability described herein. For example, embodiments of the invention using a first knob 20-1 and a second knob 20-2 to accept selection of control source, mode and media content item selections may accept sub-menu selections from traditional touch screen input devices. In another example, a traditional touch screen or pushbutton array may be used as the input device for selection of sources. Also, the control circuit 16 described here can be implemented in a variety of forms and/or located in different locations, such as on a separated circuit board, integrated within the system, in a separated component of a larger system, etc. Various other combinations of the components of embodiments of the invention, described herein, are possible within the spirit and scope of the invention.

1. A system for accepting user input, comprising:
a plurality of switches;
a pressure member coupled to the plurality of switches, the pressure member having multiple sections, wherein each section of the multiple sections is associated with a switch of the plurality of switches; and
wherein the pressure member is positioned in relation to the plurality of switches such that when a force is applied by a user to one of the multiple sections, the pressure member transmits a resulting force to a switch associated with the one of the multiple sections thereby causing actuation of the switch associated with the one of the multiple sections.

2. The system of claim 1 further comprising a display, wherein the display displays at least one input option and wherein at least one of the multiple sections of the pressure member is spatially associated with the at least one input option displayed.

3. The system of claim 2 wherein at least a portion the pressure member is optically transparent, the pressure member is further positioned in front of the display so that the display is visible through the pressure member, the plurality of switches is further located adjacent to the display and the at least one input option displayed is viewed through the pressure member.

4. The system of claim 3 wherein the system operates in a motor vehicle.

5. The system of claim 1 wherein the system operates in a motor vehicle.

6. The system of claim 1 wherein the system operates as a component of a media player.

7. The system of claim 1 wherein the at least one of the multiple sections has a tactile element, wherein the tactile element reduces the requirement for a visual location, by the user, of the at least one of the multiple sections of the pressure member.

8. The system of claim 1 wherein the pressure member includes four sections and wherein each section is associated with one of the four switches.

9. The system of claim 1 wherein the pressure member transmits a resulting force to a single switch associated with the one of the multiple sections.

10. The system of claim 1 wherein the pressure member transmits a resulting force to at least two switches associated with the one of the multiple sections.

11. The system of claim 1 wherein the switch actuation initiates a system operation.

12. The system of claim 1 wherein the mechanical characteristics of the pressure member are spatially varied, in order to focus forces exerted upon a selected section of the pressure member to effect a desired switch actuation.

13. The system of claim 1 comprising:
a first switch of the plurality of switches;
a second switch of the plurality of switches; and
a control circuit;
wherein, as a result of the exertion of a force by the user to the pressure member, the pressure member transmits a first resulting force to a first switch associated with one of the multiple sections of the pressure member and a second resulting force to a second switch associated with another of the multiple sections of the pressure member thereby causing an actuation of the first switch of the plurality of switches and an actuation of the second switch of the plurality of switches;
whereupon the control circuit identifies a multiple switch activation as an inferred system state.

14. The system of claim 1, further comprising a fulcrum that localizes deflection of the pressure member resulting from forces applied by a user, in order to affect which switches are actuated by the applied force.

15. The system of claim 1 wherein the system, in response to the exertion of a force on the pressure member by the user, provides confirmation of a user input to the user.

16. The system of claim 1, further comprising an indicator light, wherein the indicator light upon the exertion of a force to the pressure member by a user, is configured to illuminate in order to provide a visual confirmation of the switch actuation to the user.

17. The system of claim 1 wherein the system is configured to provide an audible confirmation of the switch actuation to the user.

18. The system of claim 17 wherein the audible confirmation of the switch actuation is a synthetic voice.

19. A system for accepting user input, comprising:
a first control configured to select a media source in response to an actuation of the first control by a user;
a second control, wherein the second control has two degrees of freedom in actuation configured to choose a mode from a set of modes for the selected media source in response to an actuation of the first degree of freedom of the second control by the user, wherein actuation of the second degree of freedom by the user of the second control is configured to identify a media content item selection; and
a display for displaying one of the media source, mode and media content item.

20. The system for accepting user input of claim 19, further comprising a pressure member coupled to a plurality of switches, the pressure member having multiple sections, wherein each section of the multiple sections is associated with a switch of the plurality of switches and wherein the pressure member is positioned in relation to the plurality of switches such that when a force is applied by a user to one of the multiple sections, the pressure member transmits a resulting force to a switch associated with the one of the multiple sections thereby causing actuation of the switch associated with the one of the multiple sections.

21. The system of claim 19 wherein a control comprises a shaft, wherein the shaft is mounted within a void of the pressure member and secured by a fastener.

22. The system of claim 19 wherein the system delays, for a predetermined time, before executing one of a user media source selection, mode selection and media content item selection.

23. The system of claim 19 wherein, upon the occurrence of one of a user media source selection, mode selection, and media content item selection, the system provides a sub-menu of options to the user.

24. The system of claim 19 wherein a display is configured to provide a visual confirmation of the media source selected.

25. The system of claim 24 wherein the display displays a color cue based on a media source selected.

26. The system of claim 24 wherein the display provides a position indicator depicting to the user, the relative position of a selected media content item within a browsable list of media content items, wherein the position indicator is displayed in a radial format.

27. The system of claim 19 wherein the display is a touch screen and wherein the touch screen is configured to process a user input.

28. The system of claim 19 wherein a control is configured to provide a visual confirmation of a user input.

29. The system of claim 28 wherein the visual confirmation is text.

30. The system of claim 28 wherein the visual confirmation is a graphic.

31. The system of claim 28 wherein the visual confirmation is a color change.

32. The system of claim 28 wherein at least a portion of the control is optically transparent, wherein the control is positioned over the display and wherein information displayed by the display is visible through the control.

33. The system of claim 32 wherein the visual information is text.

34. The system of claim 32 wherein the visual information is a graphic.

35. The system of claim 32 wherein the visual information is a color change.

36. The system of claim 19 wherein the system is configured to provide an audible confirmation of the media source selected.

37. The system of claim 36 wherein the audible confirmation of the media source selected is a synthetic voice.

38. The system of claim 19 wherein a second control is positioned in front of the display and wherein the second control accepts actuation of the second degree of freedom by the user, as a user input.

39. A system for accepting user input, comprising:
at least one switch;
a display, wherein the display depicts menu options including:
media content information;
control options, wherein the control options are displayed on the display near the switch
a pressure member disposed over the display wherein at least a portion of the display is visible through the pressure member, the pressure member being configured to accept a force exerted by a user within a section of the pressure member;
the pressure member further coupled to the at least one switch such that a resulting force transmitted by the pressure member in response to a user applied force causes a switch actuation; and
at least one control, configured to accept one of a push and turn in order to select one of the menu options.

40. The system of claim 39 wherein at least a portion of the at least one control is optically transparent, wherein the at least one control is positioned over the display and wherein information displayed by the display is visible through the at least one control.

41. The system of claim 39 wherein the display displays a color to provide user feedback.

42. The system of claim 40 wherein the at least one control displays a color to provide user feedback.

43. The system of claim 40 wherein the at least one control displays an symbolic representation of a selected one of the media content source, mode and media content item.

44. The system of claim 19 for accepting user input, wherein said first control has two degrees of freedom in actuation, and wherein actuation of the first degree of freedom is associated with selection of a media source, and the second degree of freedom is associated with control of system volume.

45. A system for accepting user input in a media player, comprising:
a display for displaying one of the media source, mode and media content item;
at least one control, wherein the at least one control has two degrees of freedom in actuation, wherein the at least one control is disposed over the display and at least a portion of the control is optically transparent such that at least a portion of the display is visible through the at least one control.

46. A media player for use in a motor vehicle, comprising:
a plurality of switches;
a display for displaying one of the media source, mode and media content item;
a pressure member coupled to at least one of the plurality of switches, the pressure member disposed over the display wherein at least a portion of the display is visible through the pressure member, the pressure member being configured to accept a force exerted by a user within a section of the pressure member; and
two controls, wherein each of the two controls is located to one side of the display and wherein the controls have two degrees of freedom in actuation.

47. In a system for accepting a user input, a method for accepting the user input, comprising the steps of:
displaying a set of options on a display to prompt for a user selection, wherein at least a portion of the display is visible through a pressure member, the pressure member being positioned in front of the display;
generating a switch actuation in response to a force exerted by the user on a section of the pressure member wherein the section of the pressure member corresponds to a desired option, wherein the switch is arranged in an array of switches adjacent to the display; and
based on the switch actuation, changing a system state.

48. The method of claim 47, further comprising the step of providing a confirmation in response to the exertion of the force to the section of the pressure member by the user.

49. The method of claim 48 wherein the confirmation is an audible confirmation.

50. The method of claim 47, further comprising the step of:
based on the system state, initiating a system operation.

51. The method of claim 47 wherein the step of generating a switch actuation comprises the steps of:
detecting a first switch actuation and a second switch actuation caused by the transmission of a resulting force by the pressure member to the first switch and the second switch; and
generating an inferred system state.

52. The method of claim 51 wherein the inferred system state initiates a browse function.

53. The method of claim 47, further comprising the step of:
accepting actuation of the first degree of freedom of a first control to select one of the following sources: uIndex, AM, FM, satellite radio, compact disk, hard drive, uMusic, DVD, HVAC/climate, core navigation.

54. The method of claim 47, further comprising the step of:
accepting actuation of the first degree of freedom of a second control to select one of the following modes: AM presets, AM seek, AM tune, FM preset, FM seek, FM tune, FM station, FM song, FM genre, FM artist, satellite radio presets, satellite radio station, satellite radio category, satellite radio station, satellite radio song, satellite radio genre, satellite radio artist, CD Track, CD time, CD Disk, CD Artist, CD Song, CD Genre, hard drive title, hard drive track, hard drive artist, hard drive time, hard drive genre, uMusic track, uMusic time, DVD Chapter, HVAC/climate temperature, HVAC/climate fan, core navigation origin, core navigation destination, core navigation directions.

55. The method of claim 54, further comprising the steps of:
displaying a list of options pertinent to the selected mode; and
selecting a desired option based on actuation of the first degree of freedom of the second control.
